(19) United States
(12) Patent Application Publication
(10) Pub. No.: US 2013/0326807 A1
(43) Pub. Date: Dec. 12, 2013

(54) RECEIVING DEVICE FOR A SINK

(71) Applicant: Eun-young Ahn, Seongnam-si (KR)

(72) Inventor: Eun-young Ahn, Seongnam-si (KR)

(21) Appl. No.: 13/981,047

(22) PCT Filed: Feb. 1, 2012
(86) PCT No.: PCT/KR2012/000775

§ 371 Date: Aug. 14, 2013

(30) Foreign Application Priority Data
Feb. 1, 2011 (KR) 10-2011-0010095

(51) Int. Cl. A47J 47/20

(52) U.S. Cl. CPC A47J 47/20
USPC 4/630

(57) ABSTRACT

A storage device for a sink capable of being installed between an upper cabinet and a lower cabinet of a sink is provided. The storage device for a sink can be provided at a corner of the sink having a low degree of space utilization to easily store cutting boards, kitchen cleaners, sponges and the like. Also, since a plate provided with a storage unit is rotatably disposed on a vertical rod, the storage device for a sink can be configured to turn the plate toward a wall so that products are invisible after storage of the products, thereby tidily arranging the stored products. In addition, the storage device for a sink can be provided with hook rings, magnetic materials and tong-type grasping units to easily arrange and store products used for various purposes. The storage device for a sink includes a vertical rod fixed between an upper cabinet and a lower cabinet of a sink, a plate rotatably disposed on the vertical rod and having a rear surface disposed in a length direction of the vertical rod so as to come into surface contact with the vertical rod, and a storage unit fixed to the rear surface of the plate disposed on the vertical rod to form a plurality of storage spaces.

### CROSS-REFERENCE TO RELATED APPLICATION

This application claims priority to and the benefit of Korean Patent Application No. 2011-0010095, filed Feb. 1, 2011, the disclosure of which is incorporated herein by reference in its entirety.

### BACKGROUND

1. Field of the Invention

The present invention relates to a storage device for a sink, and, more particularly, to a storage device for a sink capable of being installed between an upper cabinet and a lower cabinet of a sink, preferably being disposed at a corner of the sink having a low degree of space utilization so as to easily store cutting boards, kitchen cleaners, sponges and the like, capable of being configured to rotatably dispose a plate provided with a storage unit on a vertical rod, and thus turn a plate toward a wall so that products are invisible after storage of the products, thereby tidily arranging the stored products, and capable of being provided with hook rings, magnetic materials and tong-type grasping units to easily arrange and store products used for various purposes.

2. Discussion of Related Art

In general, a dinner set and various kitchen utensils including cutting boards, knives, kitchen cleaners, sponges, cups, scissors, pairs of rubber gloves, dish towels, ladles and the like are stored and furnished for use in a sink.

However, such kitchen utensils may not be easily arranged together with kitchen utensils used for the other purposes since they have their way to be stored for their own uses, and thus get confused even when they are arranged together with the kitchen utensils used for the other purposes.

In this case, when all the products such as kitchen utensils are stored together in cabinets of the sink, one has to do cumbersome works to rummage and take out the products whenever necessary. Accordingly, there is an increasing demand for a storage device for sinks capable of tidily and easily storing kitchen utensils which have been frequently used

### SUMMARY OF THE INVENTION

The present invention is designed to solve the problems of the prior art, and therefore it is an object of the present invention to provide a storage device for a sink capable of being installed between an upper cabinet and a lower cabinet of a sink, preferably being disposed at a corner of the sink having a low degree of space utilization so as to easily store cutting boards, kitchen cleaners, sponges and the like.

It is another object of the present invention to provide a storage device for a sink capable of being configured to rotatably dispose a plate provided with a storage unit on a vertical rod, and thus turn the plate toward a wall so that products are invisible after storage of the products, thereby tidily arranging the stored products.

It is still another object of the present invention to provide a storage device for a sink capable of being provided with hook rings, magnetic materials and tong-type grasping units to easily arrange and store products used for various purposes.

One aspect of the present invention provides a storage device for a sink, which includes a vertical rod fixed between an upper cabinet and a lower cabinet of a sink, a plate rotatably disposed on the vertical rod and having a rear surface disposed in a length direction of the vertical rod so as to come into surface contact with the vertical rod, and a storage unit fixed to a rear surface of the plate disposed on the vertical rod to form a plurality of storage spaces.

According to preferred embodiments of the present invention, the storage unit may include a storage shelf configured to couple a plurality of wires in the form of a lattice and having a pair of storage spaces provided at one side thereof and a “U”-shaped fixing groove formed at the other side thereof to secure a cutting board, and fixing members each having one side fixed to one side of the rear surface of the plate and the other side fixed to one side of the storage shelf so as to fix the storage shelf to the plate.

According to more preferred embodiments of the present invention, a gutter may be detachably coupled to a lower side of the storage shelf in a sliding manner.

According to still more preferred embodiments of the present invention, the plate may be disposed in a length direction of the vertical rod so that the rear surface of the plate can come into surface contact with the vertical rod, and the vertical rod may be provided so that a length of the vertical rod can be adjusted.

According to further preferred embodiments of the present invention, a plurality of punching holes may be formed through the plate, and hook rings may be detachably disposed in the punching holes, respectively.

According to further preferred embodiments of the present invention, the plate may be formed of a metal material, and a plurality of magnetic materials may be detachably disposed on the plate formed of the metal material by means of a magnetic force.

According to further preferred embodiments of the present invention, tong-type grasping units may be fixatively disposed at both sides of the rear surface of the plate.

### BRIEF DESCRIPTION OF THE DRAWINGS

The above and other objects, features and advantages of the present invention will become more apparent to those of ordinary skill in the art by describing in detail exemplary embodiments thereof with reference to the attached drawing, in which:

FIG. 1 is a perspective view showing a storage device for a sink according to one exemplary embodiment of the present invention;

FIGS. 2 through 5 are operation diagrams of the storage device for a sink according to one exemplary embodiment of the present invention; and

FIGS. 6 through 10 are state diagrams of the storage device for a sink according to one exemplary embodiment of the present invention upon use thereof.

### DETAILED DESCRIPTION OF EXEMPLARY EMBODIMENTS

Exemplary embodiments of the present invention are described below in sufficient detail to enable those of ordinary skill in the art to embody and practice the present invention. It is important to understand that the present invention may be embodied in many alternate forms and should not be construed as limited to the exemplary embodiments set forth herein.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

With reference to the appended drawings, exemplary embodiments of the present invention will be described in detail below. To aid in understanding the present invention, like numbers refer to like elements throughout the description of the figures, and the description of the same elements will be not reiterated.

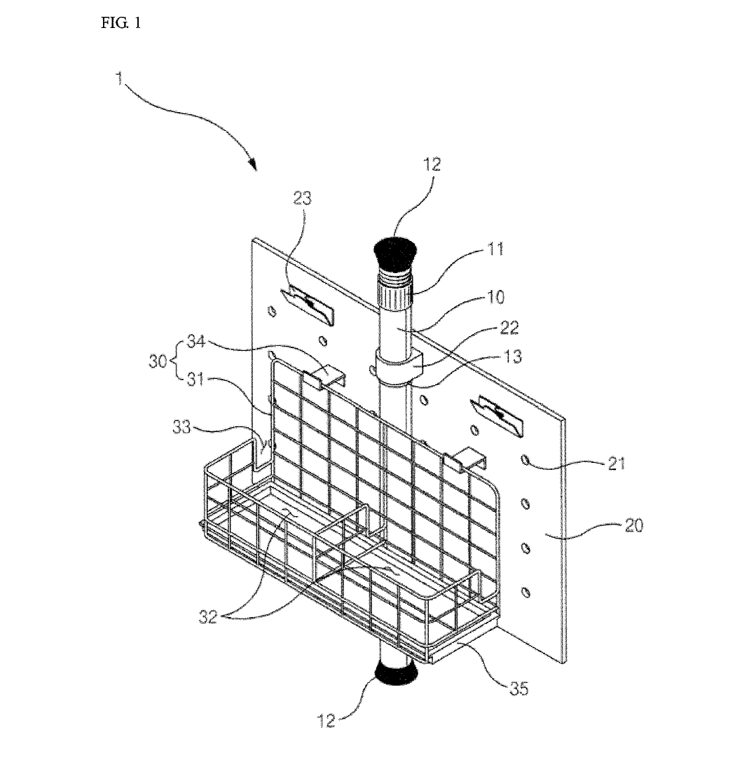

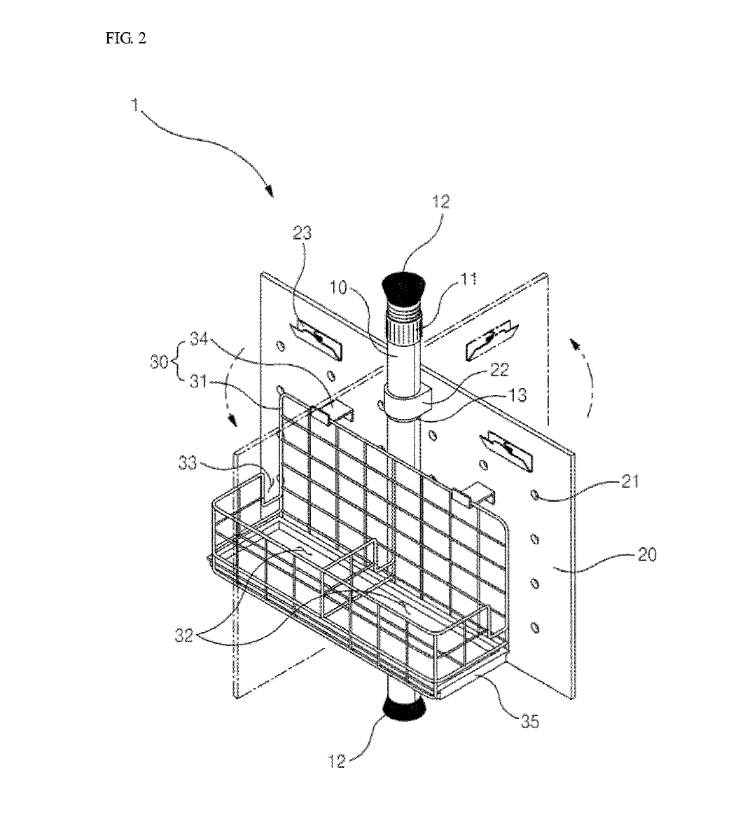

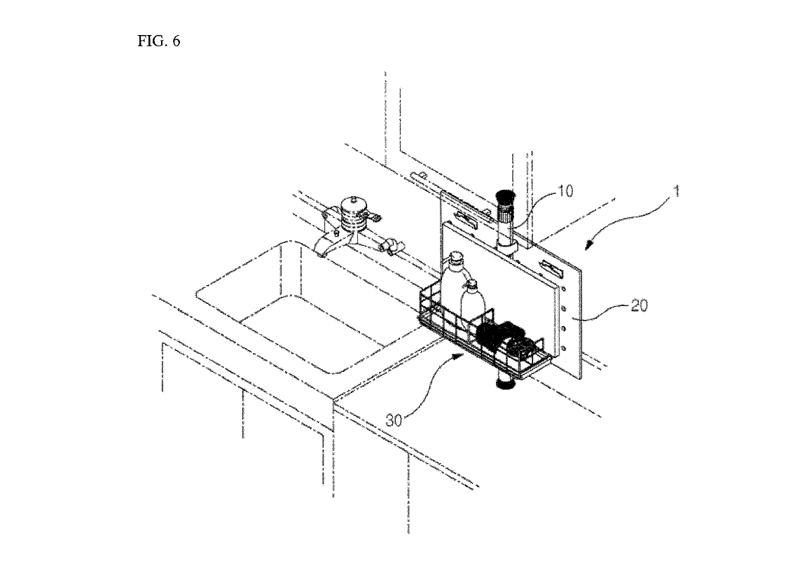

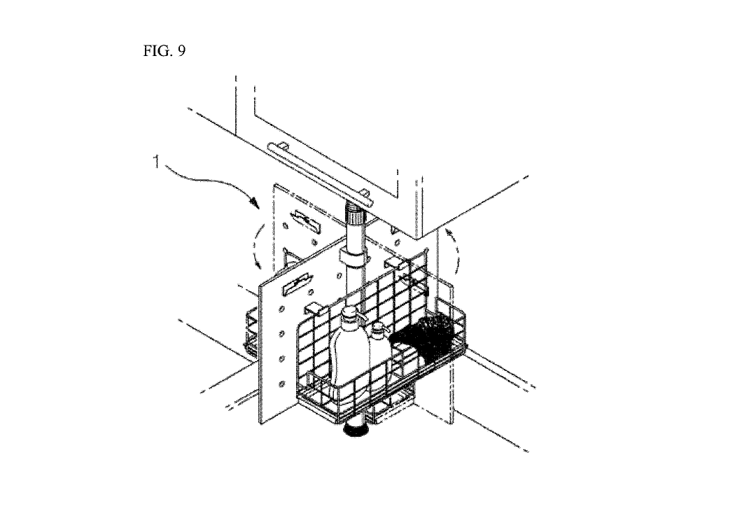

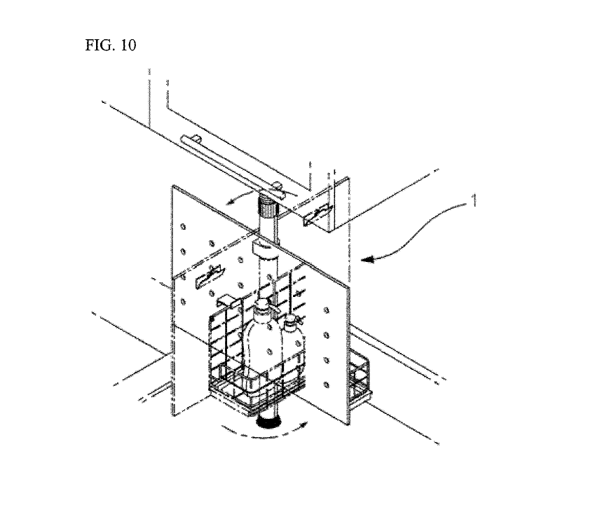

FIG. 1 is a perspective view showing a storage device for a sink according to one exemplary embodiment of the present invention, FIGS. 2 through 5 are operation diagrams of the storage device for a sink according to one exemplary embodiment of the present invention, and FIGS. 6 through 10 are state diagrams of the storage device for a sink according to one exemplary embodiment of the present invention upon use thereof.

The storage device 1 for a sink according to one preferred exemplary embodiment of the present invention includes a vertical rod 10 fixed between an upper cabinet and a lower cabinet of a sink, a plate 20 rotatably disposed on the vertical rod 10 and having a rear surface disposed in a length direction of the vertical rod 10 so as to come into surface contact with the vertical rod 10, and a storage unit 30 fixed to a rear surface of the plate 20 disposed on the vertical rod 10 to form a plurality of storage spaces 32.

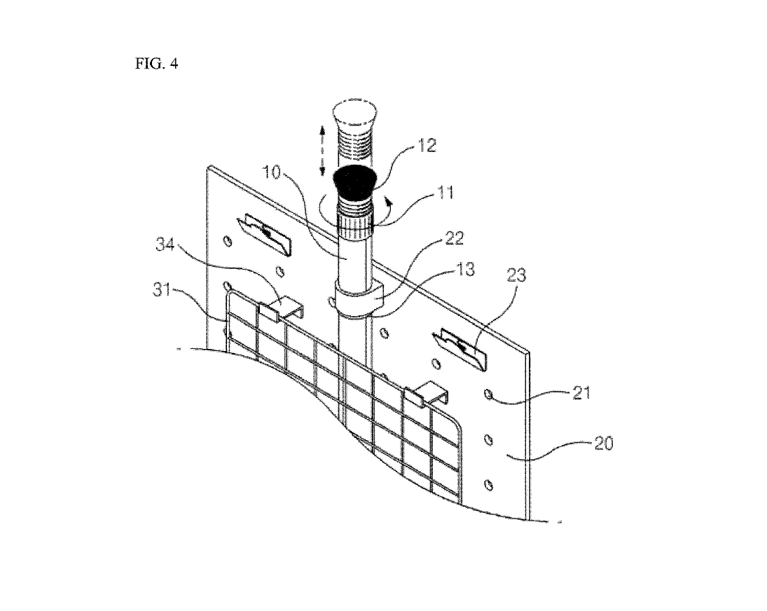

In this case, the vertical rod 10 is fixatively disposed between the upper cabinet and the lower cabinet of the sink, and serves to mount structural members as will be described later. Since the above-described vertical rod 10 should be firmly fixed and installed between the upper cabinet and the lower cabinet to prevent movement of the structural members, a rotary length adjusting member 11 configured to adjust a length of the vertical rod 10 in a rotation direction of the vertical rod 10 is provided, as shown in FIG. 4. Also, rubber packing units 12 are provided respectively at both ends of the vertical rod 10 to firmly secure the vertical rod 10 to the upper cabinet and the lower cabinet of the sink. Protrusion members 13 as will be described later are bulgingly formed respectively at upper and lower sides of the vertical rod 10 so as to secure and rotate the plate 20.

In general, the vertical rod 10 is adjustable in length by means of the above-described rotary length adjusting member 11. As a result, although there are varying gaps formed between the upper cabinet and the lower cabinet of the sink, the vertical rod 10 may be adjusted in length accordingly. It is contemplated that various methods known in the related art may be selected and used as such a length adjusting method in addition to the method using the rotary length adjusting member 11.

Since the plate 20 is rotatably disposed on the above-described vertical rod 10, the plate 20 serves to mount structural members, as will be described later, so that the structural members can be used to store products. In this case, the plate 20 is rotatably disposed on the above-described vertical rod 10, and thus may have a rear surface disposed in a length direction of the vertical rod 10 so as to come into surface contact with the vertical rod 10.

As shown in the accompanying drawings, the plate 20 is formed in a rectangular shape. Here, the plate 20 has a pair of fixing pieces 22 disposed at a rear surface thereof to be secured and rotated on the above-described protrusion members 13 of the vertical rod 10. That is, the plate 20 is fixed onto the vertical rod 10 by means of the pair of fixing pieces 22, and rotatably secured on the protrusion members 13 at the same time. As a result, the plate 20 is vertically in fixed in that position, but may be longitudinally rotated, as shown in FIG. 2.

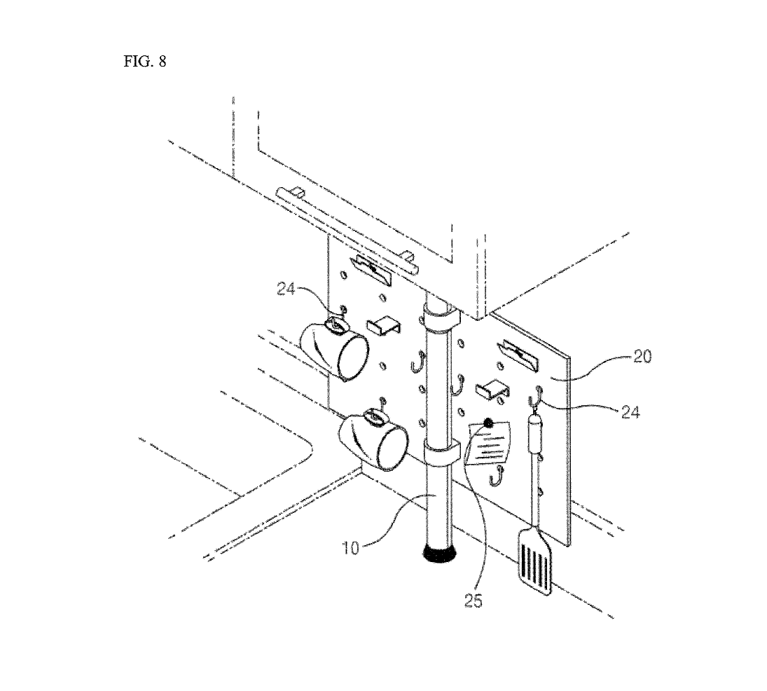

Also, a plurality of punching holes 21 are formed on the above-described plate 20 so that the plurality of punching holes 21 can pass through the plate 20. In this case, the punching holes 21 serve to detachably couple hook rings, and thus may conveniently keep various products such as a ladle or a mug while hanging the products on the hook rings coupled to the punching holes 21, as shown in FIG. 8.

In addition, the plate 20 may be formed of a metal material to attach and detach magnetic materials 25 by means of a magnetic force, and thus serves to easily fix and carry various products such as scratch papers and receipts, as shown in FIG. 8.

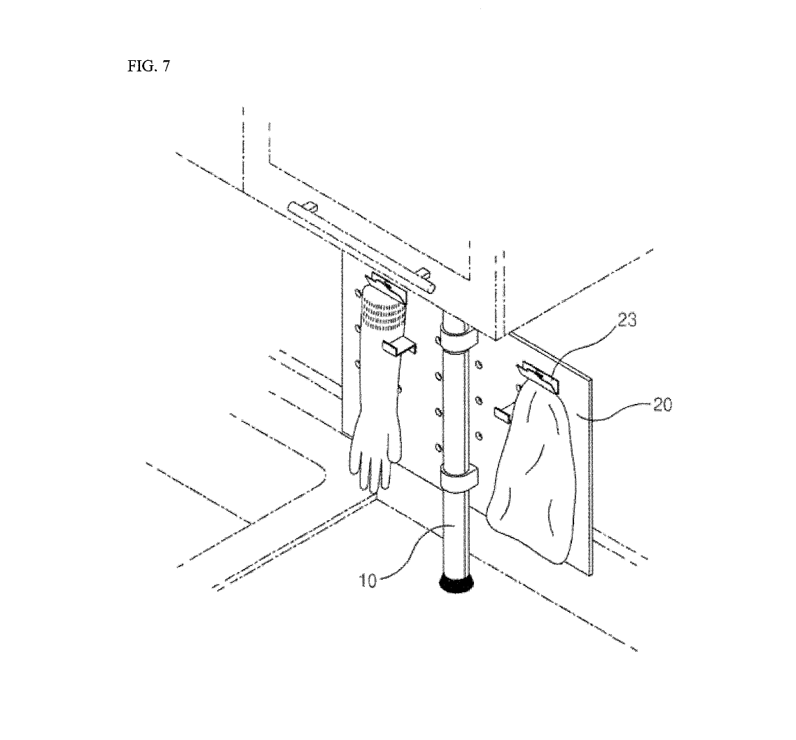

Then, tong-type grasping units are fixatively disposed at both ends of the rear surface of the plate 20. As shown in FIG. 7, the tong-type grasping units serve to carry products such as a pair of rubber gloves and/or a dish towel in a state in which the products are picked up with a pair of tongs. In this case, the tong-type grasping units may be used devoid of the storage unit 30 as will be described later, or may be used in which the storage unit 30 is mounted on the tong-type grasping units, as shown in FIG. 7.

The storage unit 30 is disposed at the rear surface of the plate 20 having the above-described tong-type grasping units disposed thereon. In this case, the storage unit 30 serves to store cutting boards, kitchen cleaners, sponges and the like, and includes a storage shelf 31 configured to couple a plurality of wires in the form of a lattice and having a pair of storage spaces provided at one side thereof and a “U”-shaped fixing groove 33 formed at the other side thereof to secure a cutting board, and fixing members 34 each having one side fixed to one side of the rear surface of the plate 20 and the other side fixed to one side of the storage shelf 31 so as to fix the storage shelf 31 to the plate 20.

The fixing members 34 are positioned at both sides of the rear surface of the plate 20 while protruding forward by a thickness of the vertical rod 10, and end portions of the fixing members 34 are formed in a curved shape. In this case, since the storage shelf 31 is formed in a lattice shape, an upper portion of the storage shelf 31 is hung on the fixing members 34 and fixed in that position, and a lower portion of the storage shelf 31 is supported by the vertical rod 10.

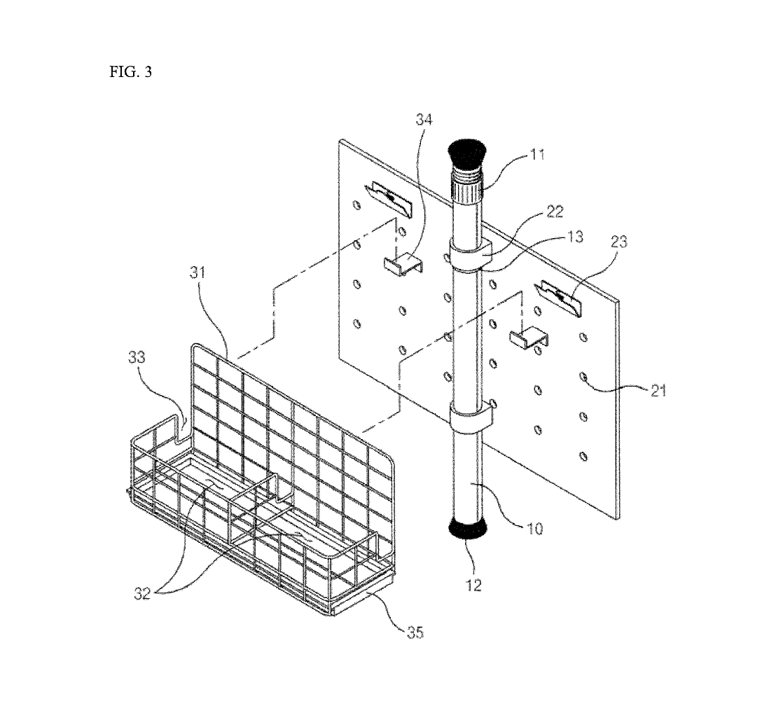

Therefore, the storage shelf 31 may be easily attached and detached to/from the fixing member 34, as shown in FIG. 3. As shown in FIG. 6, the storage shelf 31 may also be arranged so that a cutting board can be put on the “U”-shaped fixing groove 33, and a kitchen cleaner and a sponge can be stored in a pair of storage spaces 32.

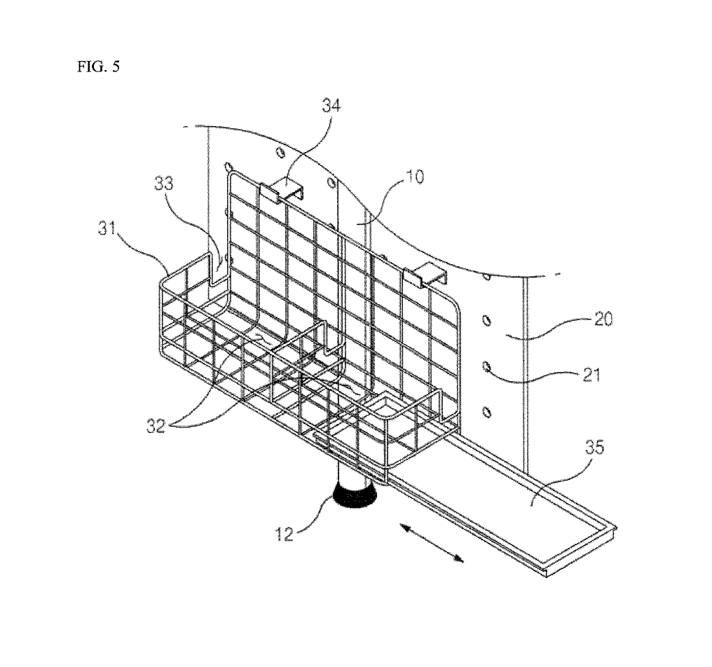

As shown in FIG. 5, a gutter 35 may be detachably disposed at a lower portion of the storage shelf 31 in a sliding manner, and thus serves to collect water dropping from the cutting board, the sponge and the like, thereby preventing contamination of the lower cabinet.

Meanwhile, the storage device 1 for a sink is disposed at one side of a sink to store various products, as described above. In this case, the storage device 1 for a sink may be rotatably disposed to turn the rear surface of the plate 20, in which the storage units 30 carrying the products is disposed, toward a wall of the sink, thereby tidily arranging the stored products.

Also, the storage device 1 for a sink may be installed at a space, such as a sink corner, which has a low degree of space utilization, thereby effectively utilizing a dead space.

As described above, the storage device for a sink according to one preferred exemplary embodiment of the present invention has the following effects:

First, the storage device for a sink can be installed between an upper cabinet and a lower cabinet of a sink, preferably be disposed at a corner of the sink having a low degree of space utilization so as to easily store cutting boards, kitchen cleaners, sponges and the like.

Second, the storage device for a sink can be configured to rotatably dispose a plate provided with a storage unit on a vertical rod, and thus turn a plate toward a wall so that products are invisible after storage of the products, thereby tidily arranging the stored products.

Third, the storage device for a sink can be provided with hook rings, magnetic materials and tong-type grasping units to easily arrange and store products used for various purposes.

While the invention has been shown and described with reference to certain exemplary embodiments thereof, it will be understood by those skilled in the art that various changes in form and details may be made therein without departing from the scope of the invention as defined by the appended claims.

1. A storage device for a sink, comprising:
a vertical rod fixed between an upper cabinet and a lower cabinet of a sink;
a plate rotatably disposed on the vertical rod; and
a storage unit fixed to a rear surface of the plate disposed on the vertical rod to form a plurality of storage spaces.

2. The storage device for a sink according to claim 1, wherein the storage unit comprises:
a storage shelf configured to couple a plurality of wires in the form of a lattice and having a pair of storage spaces provided at one side thereof and a “U”-shaped fixing groove formed at the other side thereof to secure a cutting board; and
fixing members each having one side fixed to one side of the rear surface of the plate and the other side fixed to one side of the storage shelf so as to fix the storage shelf to the plate.

3. The storage device for a sink according to claim 2, wherein a gutter is detachably coupled to a lower side of the storage shelf in a sliding manner.

4. The storage device for a sink according to claim 1, wherein the plate is disposed in a length direction of the vertical rod so that the rear surface of the plate comes into surface contact with the vertical rod, and the vertical rod is provided so that a length of the vertical rod can be adjusted.

5. The storage device for a sink according to claim 1, wherein a plurality of punching holes are formed through the plate, and hook rings are detachably disposed in the punching holes, respectively.

6. The storage device for a sink according to claim 1, wherein the plate is formed of a metal material, and a plurality of magnetic materials are detachably disposed on the plate formed of the metal material by means of a magnetic force.

7. The storage device for a sink according claim 6, wherein tong-type grasping units are fixatively disposed at both sides of the rear surface of the plate.

8. The storage device for a sink according claim 5, wherein tong-type grasping units are fixatively disposed at both sides of the rear surface of the plate.

9. The storage device for a sink according claim 4, wherein tong-type grasping units are fixatively disposed at both sides of the rear surface of the plate.

10. The storage device for a sink according claim 3, wherein tong-type grasping units are fixatively disposed at both sides of the rear surface of the plate.

11. The storage device for a sink according claim 2, wherein tong-type grasping units are fixatively disposed at both sides of the rear surface of the plate.

12. The storage device for a sink according claim 1, wherein tong-type grasping units are fixatively disposed at both sides of the rear surface of the plate.
